(19) United States
(12) Patent Application Publication
(10) Pub. No.: US 2013/0160987 A1
(43) Pub. Date: Jun. 27, 2013

(54) COOLING

(71) Applicant: Vartan Grigorian, Melton Mowbray (GB)

(72) Inventor: Vartan Grigorian, Melton Mowbray (GB)

(73) Assignee: PERA INNOVATION LIMITED, Leicestershire (GB)

(21) Appl. No.: 13/712,727

(22) Filed: Dec. 12, 2012

Related U.S. Application Data
(63) Continuation of application No. 13/386,792.

(30) Foreign Application Priority Data
Jul. 30, 2009 (GB) 0913226.7

(51) Int. Cl. G07F 9/10

(52) U.S. Cl. CPC G07F 9/105
USPC 165/267

(57) ABSTRACT

The present invention relates to improvements in or relating to cooling, in particular for cooling beverages in containers such as cans or bottles. We describe a cooling apparatus having a cavity for receipt of a product to be cooled; rotation means to rotate a product received in the cavity and cooling liquid supply means to provide a cooling liquid to the cavity. The rotation means is adapted to rotate the product at a rotational speed of 90 revolutions per minute or more and is also adapted to provide a pulsed or non-continuous rotation for a predetermined period.

### BACKGROUND

The present invention relates to improvements in or relating to cooling.

In catering, retail and entertainment sectors, various forms of vending devices are used in order to keep products chilled. For cold beverages these devices form two typical groups—commercial drinks refrigerators and cold beverage vending machines. Both types of device are essentially large glass-fronted refrigerators having hinged or sliding doors in the case of the first group (for manual dispensing) or a dispensing mechanism in the case of the second. They pre-cool and store drinks ready for purchase. In many cases, the drinks are maintained at low temperatures for long periods before they are eventually purchased. As a result, considerable energy is used, potentially unnecessarily. Compounding the problem, both types of device operate inefficiently. In use, drinks refrigerators of the first group suffer substantial loss of cold air every time the large door is opened. Vending machines must provide easy passage to the vending tray where the item is collected by the user, resulting in poor sealing. Refrigeration systems generally have a requirement to be exercised through background running cycles to maintain efficiency, but this uses additional energy not directly contributing to chilling the contents.

It is also known for many beverage retailers to stock beverages in open-fronted refrigerated cabinets for ease of access and visibility of product. These cabinets obviously suffer even greater energy wastage.

The net result is high levels of wasted electrical energy used in keeping drinks in a long-term cold state in readiness for purchasing, regardless of whenever that might occur.

Energy wastage is not confined to corporate sites hosting vending machines. Many small corner shops, petrol stations and café outlets host drinks chilling cabinets. For these operators, electrical energy costs will represent a high proportion of their operational overhead. Energy wastage is not the only issue. Since refrigeration systems generate heat, often the wasted heat energy by-product from the refrigeration system causes unwanted warming of the localised area around the machines. This creates an inconsistency in which users must drink their satisfactorily chilled drinks in unsatisfactorily warm areas.

Speed of cooling is also an issue, particularly in establishments having a high turnover of beverages, such as at special events—concerts, sporting eventings and so on. Often, at the start of the event, drinks are adequately cooled by having been refrigerated for several hours. However, once the event is under way, the volume of drinks being sold exceeds the capacity of the refrigerators to chill further drinks Drinks must then be sold only partially chilled or not chilled at all.

The present invention seeks to address these problems by providing an apparatus that allows cooling of beverages on demand. The apparatus can be a stand-alone device or may be incorporated into a vending machine.

### BRIEF DESCRIPTION

The present invention provides a cooling apparatus comprising a cavity for receipt of a product to be cooled. The apparatus comprises rotation means to rotate a product received in the cavity and cooling liquid supply means to provide a cooling liquid to the cavity. The rotation means is adapted to rotate the product at a rotational speed of 90 revolutions per minute or more and is further adapted to provide a pulsed or non-continuous rotation for a predetermined period.

Preferably, the rotation means is adapted to rotate the product at least about 180 revolutions per minute, more preferably at least about 360 revolutions per minute.

Preferably, the cooling fluid supply means is adapted to provide a flow of cooling liquid to the cavity.

Preferably, the cooling liquid is supplied to the cavity at a temperature of −10° C. or less, more preferably −14° C. or less, even more preferably −16° C. or less.

A cooling apparatus as claimed in any one of claims 1 to 4 wherein the rotation means is adapted to rotate the product about an axis of the product and further comprises retaining means to prevent or substantially avoid axial movement of the product during rotation.

A cooling apparatus as claimed in any one of claims 1 to 5 wherein the rotation means is adapted to rotate the product for at least one cycle of: rotation for a predetermined rotation period and non-rotation for a predetermined pause period; followed by a further predetermined period of rotation.

A cooling apparatus as claimed in claim 6 wherein the rotation means performs at least two cycles, preferably three to six cycles, more preferably three or four cycles.

A cooling apparatus as claimed in claim 6 or claim 7 wherein the predetermined rotation period is 5 to 60 seconds, preferably 5 to 30 seconds, more preferably 5 to 15 seconds, most preferably about 10 seconds.

A cooling apparatus as claimed in claim 8 wherein the predetermined pause period is 10 to 60 seconds, preferably 10 to 30 seconds.

In certain embodiments, the apparatus comprises a plurality of cavities as defined above.

In typical embodiments, the apparatus is incorporated in a vending apparatus and the vending apparatus further comprises insertion and removal means for inserting the product to be cooled into the cavity and removing the cooled product therefrom.

Preferably, the vending apparatus further comprises storage means for storing a product or range of products and selection means for selecting a product from the storage means for insertion into the cavity.

The above and other aspects of the present invention will now be described in further detail, by way of example only.

FIGS. 1 to 4 graphically show the results of cooling trials with a first embodiment of an apparatus in accordance with the present invention.

### BRIEF DESCRIPTION OF THE DRAWINGS

FIG. 1 is a chart of test results examining the effect of the speed of rotation on the cooling of a container;

FIG. 2 is a chart of test results comparing continuous rotation and intermittent rotation of a container on cooling results;

FIG. 3 is a chart of test results comparing different intermittent rotation rpms and number of spins on cooling results; and

FIG. 4 is a chart comparing temperature versus time showing the average results of a larger series of trials.

### DETAILED DESCRIPTION

In discussing the present invention, a brief review of current methods for selectively cooling beverages on a container-by-container basis will be helpful. A typical 330 ml aluminium can containing a beverage can be cooled in a refrigerator set at a typical operating temperature of around 4 to 5° C. from an ambient temperature of 25° C. to a comfortable drinking temperature of 6° C. in approximately four hours or so. In a freezer, the period is reduced to around 50 minutes.

Peltier coolers are available and are based on the physics of the Peltier effect, which occurs when a current is passed through two dissimilar metals coupled in a face-to-face arrangement. One of the metals will heat up and the other will cool down. The cold side in contact with the cooling chamber of the can reduces the can temperature.

Peltier coolers are already extremely popular in high-end computer cooling systems and scientific CCD imaging systems. They have been applied to portable cool boxes and in-vehicle refrigerators, where a compressor would be too noisy or bulky. A cooling cycle time for a standard can is in excess of 30 to 45 minutes. In addition, because the Peltier element is typically located adjacent the concave base of the can, the can is cooled very unevenly. As a result these devices are only really suitable for maintaining the temperature of a pre-chilled drink

Gel-based cooling jackets, may, depending on their size, cool a can or bottle in under 15 minutes. These work by encapsulating a high concentration of sodium-based phase-change material into a sleeve, designed to fit closely around the can. This sleeve must then be cooled in a freezer and then re-cooled after each use.

The current state of the art methodology for cooling bottles and cans is considered to be the Cooper cooler. The unit slowly rotates a beverage container horizontally, whilst covering or immersing the container in ice-cold water. From a 25° C. starting temperature a bottle may be cooled to 11° C. in 3.5 minutes and to 6° C. in 6 minutes. In addition, the unit requires a substantial supply of ice cubes to chill adequately. This technology is not sufficiently fast for commercial applications, it requires a large number of ice cubes and results in damage to the branding labels on the bottle.

Within a carbonated drink, carbon dioxide is dissolved in the liquid under pressure (Henry's Law). When the pressure is reduced (upon opening), the liquid becomes less capable of holding carbon dioxide (CO₂), and so the CO₂ will come out of solution. All carbonated drinks therefore effervesce (fizz) upon opening as the internal pressure of their container is reduced. Whether they fizz over (liquid comes out of the container explosively) depends on how quickly CO₂ comes out of solution. Effervescence is enhanced by the availability of nucleation sites in the container which act as foci for the formation of bubbles.

We have determined that a carbonated drink will not effervesce excessively up when rotated at high speeds because nucleation does not occur. In comparison, when a carbonated drink is shaken, the air pocket above the beverage is broken up into a large number of small pockets dispersed throughout the beverage which then act as nucleation sites when the can is opened. The CO₂ then expands rapidly, carrying the liquid out of the can. However, when a beverage is only rotated, the air pocket stays substantially intact. There are few, if any, nucleation sites dispersed throughout the liquid, and the slow decarbonation takes place.

We have developed an apparatus comprising a cavity for receipt of a can or other container for a beverage to be cooled. The cavity includes a motor-driven turntable to allow the can to be rotated at speed and also includes a clamp to hold the can in position on the turntable whilst permitting rotation. The apparatus also includes supply means for a cooling liquid.

In its crudest form, the cooling liquid is simply poured into the cavity and then removed at the end of the cooling process. In preferred embodiments, a flow of cooling liquid through the apparatus is provided.

In trials, we investigated the effects of spray cooling and liquid flow cooling on a can surface. These trials showed that liquid flow cooling provided better results. Spray cooling technology did not efficiently cool the central point of the can, providing only the external impression of a cold can but not a sufficiently cooled drink.

We then conducted a series of trials investigating the optimal methodology of agitating a can at different speeds seeking to avoid fizzing. These experiments showed that a can may be rotated at 360 rpm for over 5 minutes without fizzing. Axial agitation motions resulted on a non even mix or violent fizzing actions.

To further develop the concept, a sealed can cooling rig was manufactured to use a salt water solution which is chilled down to approximately −16° C., in a cooling tank with a rotating agitator to reduce salt solidification. A diaphragm pump was used to fill the cooling vessel, at a rate of up to 5 litres/min The cooling vessel has been designed to accept a standard can, which may be rotated up to 12 Hz/720 rpm. The flow rate of the pump and rotational speed of the can are controllable. The real-time cooling rates of the drink were recorded.

We have determined that, during rotation of a can, a forced vortex develops, the depth of which inside the can is dependent upon the speed of rotation. Forced convection takes place and creates artificially-induced convection currents inside the can. When the rotation is then stopped, a free or collapsing vortex forms and natural convection takes place, promoting mixing of the contents of the can but without incorporation of air bubbles which might lead to nucleation and excessive effervescing.

However, in a static can without this collapsing vortex, cooler beverages being denser, sinks to the base of the can. Mixing of the can contents is very poor leading to poor thermal uniformity, and also leading, in many cases, to ice formation or “slushing”.

We conducted a range of trials to assess the success of various rotational speeds in producing a uniformly cooled beverage. The following experiments help illustrate the invention.

Comparative Test

Initially, we conducted a trial without any rotational agitation of the can. The results are shown in Table 1.

TABLE 1

| | | Tank | Tank | Temp | Temp | | |
|---|---|---|---|---|---|---|---|
| Cooling | Number | start | end | Can | Can | Temp | Average |
| time | of spin | temp | temp | base | middle | Can top | Temp |
| (sec) | cycles | (° C.) | (° C.) | (° C.) | (° C.) | (° C.) | (° C.) |
| 60 | 0 | −17 | −16 | 5 | 18 | 20 | 14.3 |

As can be seen, from an ambient temperature of 20-22° C. The contents of the base of the can are satisfactorily cooled to a desirable temperature, but there is minimal cooling of the top of the can, giving a wide temperature range throughout the can and poor average cooling.

Experimental Tests

In the first group of tests, we sought to examine the effect of the speed of rotation on the cooling results. The results are shown in FIG. 1 in which the temperature scale represents the average temperature of the contents of the can. It will be seen that improved results are obtained at higher rotation speeds, with more rapid cooling being achieved at 360 rpm (Test 3) compared with at 180 rpm (Test 2) or at 90 rpm (Test 1). In these trials, it was noted that, as would be expected, pre-chilling of the cooler cavity had a substantial effect on successful chilling of the can contents. It was also noted that, at 180 rpm, there remained a 6° C. difference between the temperatures at the top and the base of the can.

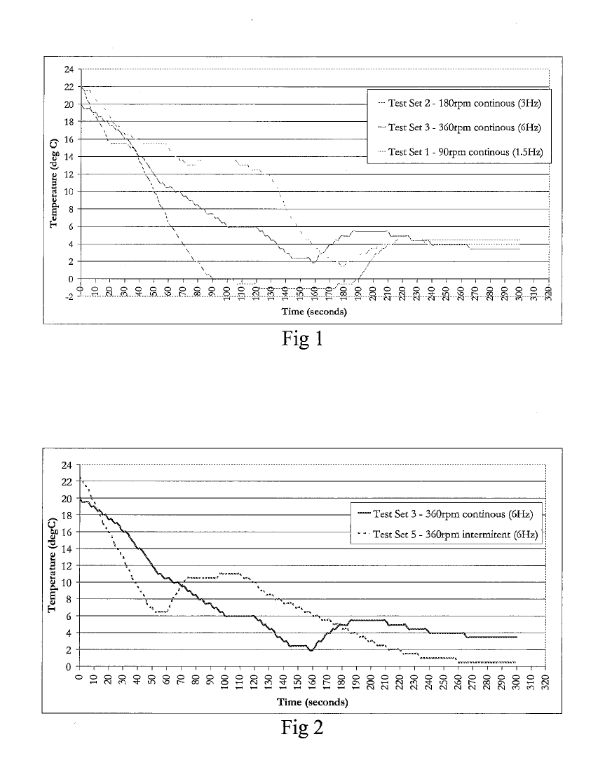

We then set out to investigate whether intermittent rotation had a better effect on cooling than continuous rotation. It will be appreciated that intermittent rotation allows the vortex to collapse several times during the cooling process and so might be expected to promote more even temperature distribution. The results are shown in FIG. 2 and illustrate that more rapid cooling was achieved with intermittent cooling.

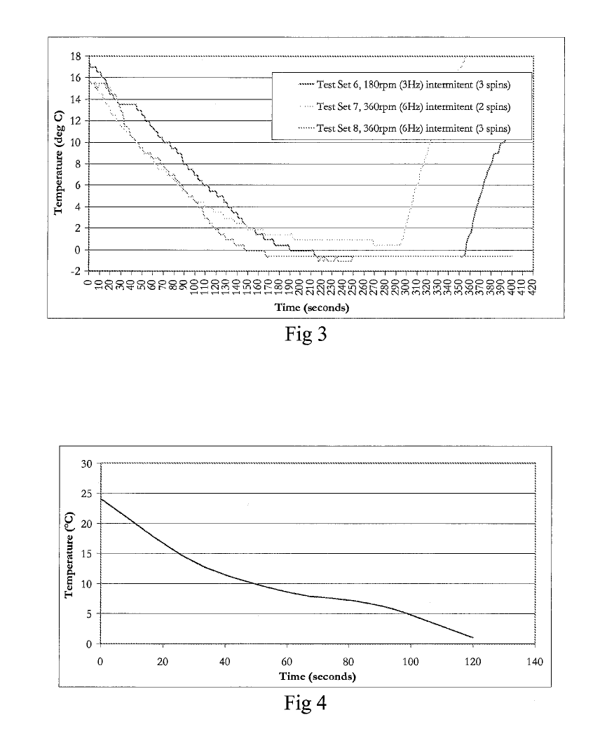

We then conducted further trials, varying the number of spins per cooling cycle. The results are shown in FIG. 3. It can be seen that rotation at higher speeds and with a higher number of pauses in rotation produces a steeper cooling gradient.

Based on the above results, further trials were conducted at 360 rpm with rotation for 10 seconds followed by a 20 second pause to show the effect over time on can temperature. The results are shown in Table 2.

TABLE 2

| | | Tank | Tank | Temp | Temp | | |
|---|---|---|---|---|---|---|---|
| Cooling | Number | start | end | Can | Can | Temp | Average |
| time | of spin | temp | temp | base | middle | Can top | Temp |
| (sec) | cycles | (° C.) | (° C.) | (° C.) | (° C.) | (° C.) | (° C.) |
| 0 | — | — | — | 24 | 24 | 24 | 24 |
| 30 | 1 | −16 | −15 | 13 | 14 | 14 | 13.6 |
| 60 | 2 | −14 | −12 | 8 | 9 | 9 | 8.6 |
| 90 | 3 | −15 | −14 | 7 | 6 | 6 | 6.3 |
| 90 | 3 | −14 | −12 | 7 | 6 | 6 | 6.3 |
| 120 | 4 | −14 | −13 | 1 | 1 | 1 | 1 |

These results show that optimum cooling, in terms of achieving a beverage cooled uniformly to the desired temperature in the range of 6° C., is achievable with three cycles, over 90 seconds. It was noted that the cooling liquid (4 litres) rose in temperature by 1.5° C. for each trial. FIG. 4 shows the averaged results of a large series of these trials with cans at initial temperatures of 24° C.

We have calculated that the total energy required to cool a can from an ambient temperature of about 24° C. to about 6° C. is around 6 joules; according to the following calculations:

Mass of drinks can=355 g water+39 g (typical) sugar

Thermal Energy, Q=Mass×Specific Heat Capacity×Change in temperature

Theoretical Drink Calculation

Q_{drink}=M×C×ΔT

Q_{drink}=0.394×0.58×−18

Q_{drink}=4.11 joules

Theoretical Can Calculation

Q_{can}M×C×ΔT

Q_{can}=(surface area×thickness×mass of aluminium)×237×48

Q_{can}=(0.032012×0.00025×56.5)×237×−18

Q_{can}=1.93 joules

Total energy required to cool a single can+beverage=Q_{can}+Q_{drink}=6.04 joules

The following set out the principle advantages of the apparatus of the present invention over the state of the art cooling methodologies:
1. Rotating the can at an optimal speed to improve forced convection;
2. Generating a free (decaying) vortex within the can to promote natural cooling convection; and
3. Combining a series of forced and free (decaying) vortexes to cool a beverage rapidly, with an evenly distributed temperature.

In preferred embodiments, the apparatus further comprises a sleeve into which the container to be cooled is filled, such as a rubber membrane, preferably a membrane including metallic particles to improve thermal conductivity. The inclusion of a closely-fitting membrane acts to reduce or prevent damage to labelling on the container, especially if paper labels are used.

The full results data from Tests 1 to 7 are given in Table 3.

For commercial uses, it is advantageous for the apparatus to include a plurality of cavities of the type described above for simultaneous chilling of several containers.

In typical embodiments, the apparatus is incorporated in a vending apparatus and further comprises insertion and removal means for inserting the product to be cooled into the cavity and removing the cooled product therefrom.

Preferably, the vending apparatus further comprises storage means for storing a product or range of products and selection means for selecting a product from the storage means for insertion into the cavity.

The vending apparatus will typically also include payment collection apparatus such as a coin-operated mechanism or a card-reading apparatus for deducting a charge from a card.

TABLE 3

| | | | | | Test Set 5 | Test Set 6 | Test Set 7 |
|---|---|---|---|---|---|---|---|
| | Test Set 1 | Test Set 2 | Test Set 3 | Test Set 4 | 180 rpm | 360 rpm | 360 rpm |
| | 90 rpm | 180 rpm | 360 rpm | 360 rpm | (3 Hz) | (6 Hz) | (6 Hz) |
| | continuous | continuous | continuous | intermittent | intermittent | intermittent | intermittent |
| Cooling | (1.5 Hz) | (3 Hz) | (6 Hz) | (6 Hz) | (3 spins) | (2 spins) | (3 spins) |
| time/ | Can | Can | Can | Can | Can | Can | Can |
| sec | Temperature | Temperature | Temperature | Temperature | Temperature | Temperature | Temperature |
| 0 | 22.021 | 22.021 | 20.023 | 22.522 | 17.51 | 16.002 | 16.002 |
| 2 | 21.52 | 21.52 | 19.52 | 22.021 | 17.008 | 15.5 | 15.5 |
| 4 | 21.52 | 20.518 | 19.52 | 21.52 | 17.008 | 15.5 | 15.5 |
| 6 | 21.52 | 20.017 | 19.52 | 21.019 | 17.008 | 15.5 | 14.997 |
| 8 | 21.019 | 19.015 | 19.018 | 20.017 | 16.505 | 14.997 | 14.997 |
| 10 | 20.518 | 18.514 | 19.018 | 19.516 | 16.505 | 14.494 | 15.5 |
| 12 | 20.017 | 18.012 | 18.515 | 18.514 | 16.002 | 14.494 | 15.5 |
| 14 | 20.017 | 17.511 | 18.515 | 18.012 | 16.002 | 13.991 | 15.5 |
| 16 | 19.516 | 17.01 | 18.013 | 17.01 | 15.5 | 13.488 | 14.997 |
| 18 | 19.015 | 16.008 | 18.013 | 16.509 | 14.997 | 13.488 | 14.997 |
| 20 | 18.514 | 15.507 | 17.51 | 16.008 | 14.494 | 12.986 | 14.997 |
| 22 | 18.012 | 15.507 | 17.51 | 15.507 | 14.494 | 12.483 | 14.494 |
| 24 | 17.511 | 15.507 | 17.008 | 14.505 | 13.991 | 12.483 | 14.494 |
| 26 | 17.511 | 15.507 | 17.008 | 14.004 | 13.991 | 11.98 | 13.991 |
| 28 | 17.01 | 15.507 | 16.505 | 13.502 | 13.488 | 11.98 | 13.488 |
| 30 | 16.509 | 15.507 | 16.002 | 13.001 | 13.488 | 11.477 | 12.986 |
| 32 | 16.509 | 15.507 | 16.002 | 11.999 | 13.488 | 11.477 | 12.483 |
| 34 | 16.509 | 15.006 | 15.5 | 11.498 | 13.488 | 10.974 | 11.477 |
| 36 | 16.008 | 15.006 | 14.997 | 10.495 | 13.488 | 10.974 | 11.477 |
| 38 | 16.008 | 14.505 | 14.494 | 9.994 | 13.488 | 10.974 | 10.974 |
| 40 | 16.008 | 13.502 | 13.991 | 9.492 | 13.488 | 10.471 | 10.471 |
| 42 | 15.507 | 13.001 | 13.991 | 8.991 | 13.488 | 10.471 | 10.471 |
| 44 | 15.507 | 11.999 | 13.488 | 8.49 | 13.488 | 9.968 | 9.968 |
| 46 | 15.507 | 11.498 | 12.986 | 7.487 | 12.986 | 9.968 | 9.968 |
| 48 | 15.507 | 10.996 | 12.483 | 6.986 | 12.986 | 9.464 | 9.464 |
| 50 | 15.507 | 9.994 | 11.98 | 6.986 | 12.483 | 9.464 | 9.464 |
| 52 | 15.507 | 9.492 | 11.477 | 6.484 | 12.483 | 8.961 | 8.961 |
| 54 | 15.507 | 8.49 | 10.974 | 6.484 | 11.98 | 8.961 | 8.961 |
| 56 | 15.507 | 7.989 | 10.974 | 6.484 | 11.98 | 8.961 | 8.961 |
| 58 | 15.507 | 7.487 | 10.471 | 6.484 | 11.477 | 8.458 | 8.961 |
| 60 | 15.006 | 6.484 | 10.471 | 6.484 | 11.477 | 8.458 | 8.458 |
| 62 | 14.505 | 5.983 | 10.471 | 6.986 | 10.974 | 7.955 | 8.458 |
| 64 | 14.004 | 5.482 | 9.968 | 7.989 | 10.974 | 7.955 | 8.458 |
| 66 | 14.004 | 4.98 | 9.968 | 8.49 | 10.471 | 7.452 | 8.458 |
| 68 | 13.502 | 4.479 | 9.968 | 8.991 | 10.471 | 7.452 | 7.955 |
| 70 | 13.502 | 3.977 | 9.464 | 9.492 | 9.968 | 7.452 | 7.955 |
| 72 | 13.001 | 3.476 | 9.464 | 9.994 | 9.968 | 7.452 | 7.452 |
| 74 | 13.001 | 2.975 | 8.961 | 10.495 | 9.968 | 6.948 | 7.452 |
| 76 | 13.001 | 2.473 | 8.961 | 10.495 | 9.968 | 6.948 | 6.948 |
| 78 | 13.001 | 1.972 | 8.458 | 10.495 | 9.464 | 6.948 | 6.948 |
| 80 | 13.502 | 1.972 | 8.458 | 10.495 | 9.464 | 6.445 | 6.948 |
| 82 | 13.502 | 1.47 | 7.955 | 10.495 | 9.464 | 6.445 | 6.445 |
| 84 | 13.502 | 0.969 | 7.955 | 10.495 | 8.961 | 5.942 | 6.445 |
| 86 | 13.502 | 0.467 | 7.452 | 10.495 | 8.961 | 5.942 | 5.942 |
| 88 | 13.502 | 0.467 | 7.452 | 10.495 | 8.458 | 5.439 | 5.942 |
| 90 | 13.502 | −0.035 | 7.452 | 10.495 | 7.955 | 5.439 | 5.439 |
| 92 | 13.502 | −0.035 | 6.948 | 10.495 | 7.955 | 5.439 | 5.439 |
| 94 | 13.502 | −0.035 | 6.948 | 10.495 | 7.452 | 4.935 | 4.935 |
| 96 | 13.502 | −0.035 | 6.445 | 10.996 | 7.452 | 4.935 | 4.935 |
| 98 | 13.502 | −0.035 | 6.445 | 10.996 | 7.452 | 4.935 | 4.935 |
| 100 | 13.502 | −0.035 | 5.942 | 10.996 | 6.948 | 4.432 | 4.432 |
| 102 | 13.502 | −0.035 | 5.942 | 10.996 | 6.948 | 4.432 | 4.432 |
| 104 | 13.502 | −0.035 | 5.942 | 10.996 | 6.445 | 4.432 | 3.928 |
| 106 | 13.502 | −0.536 | 5.942 | 10.996 | 6.445 | 4.432 | 3.928 |
| 108 | 13.001 | −0.536 | 5.942 | 10.996 | 5.942 | 4.432 | 3.425 |
| 110 | 13.001 | −0.536 | 5.942 | 10.996 | 5.942 | 3.928 | 2.921 |
| 112 | 13.001 | −0.536 | 5.942 | 10.495 | 5.942 | 3.928 | 2.921 |
| 114 | 13.001 | −0.536 | 5.942 | 10.495 | 5.439 | 3.928 | 2.418 |
| 116 | 12.5 | −0.536 | 5.942 | 10.495 | 5.439 | 3.928 | 2.418 |
| 118 | 12.5 | −0.536 | 5.942 | 9.994 | 5.439 | 3.425 | 1.914 |
| 120 | 12.5 | −0.536 | 5.942 | 9.994 | 5.439 | 3.425 | 1.914 |
| 122 | 12.5 | −1.038 | 5.439 | 9.492 | 4.935 | 3.425 | 1.914 |
| 124 | 11.999 | −1.038 | 5.439 | 8.991 | 4.935 | 3.425 | 1.41 |
| 126 | 11.999 | −1.038 | 4.935 | 8.991 | 4.935 | 3.425 | 1.41 |
| 128 | 11.999 | −1.038 | 4.935 | 8.49 | 4.432 | 2.921 | 1.41 |
| 130 | 11.498 | −1.038 | 4.432 | 8.49 | 4.432 | 2.921 | 0.907 |
| 132 | 10.996 | −1.038 | 4.432 | 8.49 | 3.928 | 2.921 | 0.907 |
| 134 | 10.495 | −1.038 | 3.928 | 7.989 | 3.928 | 2.921 | 0.907 |
| 136 | 9.492 | −1.038 | 3.425 | 7.989 | 3.425 | 2.921 | 0.907 |
| 138 | 8.991 | −1.038 | 3.425 | 7.989 | 3.425 | 2.418 | 0.403 |
| 140 | 7.989 | −1.038 | 2.921 | 7.487 | 3.425 | 2.418 | 0.403 |
| 142 | 7.487 | −1.038 | 2.921 | 7.487 | 2.921 | 2.418 | 0.403 |
| 144 | 6.986 | −1.038 | 2.418 | 7.487 | 2.921 | 2.418 | 0.403 |
| 146 | 6.484 | −1.038 | 2.418 | 7.487 | 2.418 | 2.418 | 0.403 |
| 148 | 5.983 | −1.038 | 2.418 | 6.986 | 2.418 | 2.418 | −0.101 |
| 150 | 5.482 | −1.038 | 2.418 | 6.986 | 1.914 | 1.914 | −0.101 |
| 152 | 4.98 | −1.038 | 2.418 | 6.986 | 1.914 | 1.914 | −0.101 |
| 154 | 4.479 | −1.038 | 2.418 | 6.484 | 1.914 | 1.914 | −0.101 |
| 156 | 4.479 | −1.038 | 2.418 | 6.484 | 1.914 | 1.914 | −0.101 |
| 158 | 3.977 | −1.038 | 1.914 | 6.484 | 1.41 | 1.914 | −0.101 |
| 160 | 3.476 | −1.038 | 1.914 | 5.983 | 1.41 | 1.914 | −0.101 |
| 162 | 3.476 | −1.038 | 2.418 | 5.983 | 1.41 | 1.914 | −0.101 |
| 164 | 2.975 | −1.038 | 2.921 | 5.983 | 1.41 | 1.914 | −0.101 |
| 166 | 2.975 | −1.038 | 2.921 | 5.482 | 0.907 | 1.41 | −0.101 |
| 168 | 2.473 | −1.038 | 3.425 | 5.482 | 0.907 | 1.41 | −0.604 |
| 170 | 2.473 | −1.038 | 3.928 | 5.482 | 0.907 | 1.41 | −0.604 |
| 172 | 1.972 | −1.038 | 3.928 | 5.482 | 0.907 | 1.41 | −0.604 |
| 174 | 1.972 | −1.038 | 4.432 | 4.98 | 0.907 | 1.41 | −0.604 |
| 176 | 1.972 | −0.536 | 4.432 | 4.98 | 0.403 | 1.41 | −0.604 |
| 178 | 1.47 | −0.536 | 4.935 | 4.98 | 0.403 | 1.41 | −0.604 |
| 180 | 1.47 | −0.536 | 4.935 | 4.479 | 0.403 | 1.41 | −0.604 |
| 182 | 1.972 | −0.536 | 4.935 | 4.479 | 0.403 | 1.41 | −0.604 |
| 184 | 1.972 | −0.536 | 4.935 | 4.479 | 0.403 | 1.41 | −0.604 |
| 186 | 1.972 | −0.536 | 5.439 | 3.977 | 0.403 | 1.41 | −0.604 |
| 188 | 2.473 | −0.035 | 5.439 | 3.977 | 0.403 | 1.41 | −0.604 |
| 190 | 2.473 | −0.035 | 5.439 | 3.977 | −0.101 | 1.41 | −0.604 |
| 192 | 2.975 | 0.467 | 5.439 | 3.476 | −0.101 | 1.41 | −0.604 |
| 194 | 2.975 | 0.969 | 5.439 | 3.476 | −0.101 | 0.907 | −0.604 |
| 196 | 2.975 | 1.47 | 5.439 | 3.476 | −0.101 | 0.907 | −0.604 |
| 198 | 3.476 | 1.972 | 5.439 | 2.975 | −0.101 | 0.907 | −0.604 |
| 200 | 3.476 | 2.473 | 5.439 | 2.975 | −0.101 | 0.907 | −0.604 |
| 202 | 3.476 | 2.975 | 5.439 | 2.975 | −0.101 | 0.907 | −0.604 |
| 204 | 3.977 | 2.975 | 5.439 | 2.473 | −0.101 | 0.907 | −0.604 |
| 206 | 3.977 | 3.476 | 5.439 | 2.473 | −0.101 | 0.907 | −0.604 |
| 208 | 3.977 | 3.476 | 5.439 | 2.473 | −0.101 | 0.907 | −0.604 |
| 210 | 3.977 | 3.977 | 5.439 | 2.473 | −0.101 | 0.907 | −0.604 |
| 212 | 3.977 | 3.977 | 4.935 | 1.972 | −0.101 | 0.907 | −0.604 |
| 214 | 3.977 | 3.977 | 4.935 | 1.972 | −0.604 | 0.907 | −0.604 |
| 216 | 4.479 | 4.479 | 4.935 | 1.972 | −0.604 | 0.907 | −0.604 |
| 218 | 4.479 | 4.479 | 4.935 | 1.972 | −0.604 | 0.907 | −1.108 |
| 220 | 4.479 | 4.479 | 4.935 | 1.972 | −0.604 | 0.907 | −0.604 |
| 222 | 4.479 | 4.479 | 4.935 | 1.47 | −0.604 | 0.907 | −1.108 |
| 224 | 4.479 | 4.479 | 4.935 | 1.47 | −0.604 | 0.907 | −0.604 |
| 226 | 4.479 | 4.479 | 4.432 | 1.47 | −0.604 | 0.907 | −1.108 |
| 228 | 4.479 | 4.479 | 4.432 | 1.47 | −0.604 | 0.907 | −1.108 |
| 230 | 4.479 | 4.479 | 4.432 | 1.47 | −0.604 | 0.907 | −1.108 |
| 232 | 4.479 | 4.479 | 4.432 | 1.47 | −0.604 | 0.907 | −1.108 |
| 234 | 4.479 | 4.479 | 4.432 | 0.969 | −0.604 | 0.907 | −0.604 |
| 236 | 3.977 | 4.479 | 4.432 | 0.969 | −0.604 | 0.907 | −1.108 |
| 238 | 3.977 | 4.479 | 4.432 | 0.969 | −0.604 | 0.907 | −1.108 |
| 240 | 3.977 | 4.479 | 3.928 | 0.969 | −0.604 | 0.907 | −1.108 |
| 242 | 3.977 | 4.479 | 3.928 | 0.969 | −0.604 | 0.907 | −1.108 |
| 244 | 3.977 | 4.479 | 3.928 | 0.969 | −0.604 | 0.907 | −1.108 |
| 246 | 3.977 | 4.479 | 3.928 | 0.969 | −0.604 | 0.907 | −1.108 |
| 248 | 3.977 | 4.479 | 3.928 | 0.969 | −0.604 | 0.907 | −1.108 |
| 250 | 3.977 | 4.479 | 3.928 | 0.969 | −0.604 | 0.907 | −0.604 |
| 252 | 3.977 | 4.479 | 3.928 | 0.969 | −0.604 | 0.907 | −0.604 |
| 254 | 3.977 | 4.479 | 3.928 | 0.969 | −0.604 | 0.907 | −0.604 |
| 256 | 3.977 | 4.479 | 3.928 | 0.969 | −0.604 | 0.907 | −0.604 |
| 258 | 3.977 | 4.479 | 3.928 | 0.969 | −0.604 | 0.907 | −0.604 |
| 260 | 3.977 | 4.479 | 3.928 | 0.467 | −0.604 | 0.907 | −0.604 |
| 262 | 3.977 | 4.479 | 3.928 | 0.467 | −0.604 | 0.907 | −0.604 |
| 264 | 3.977 | 4.479 | 3.928 | 0.467 | −0.604 | 0.907 | −0.604 |
| 266 | 3.977 | 4.479 | 3.425 | 0.467 | −0.604 | 0.907 | −0.604 |
| 268 | 3.977 | 4.479 | 3.425 | 0.467 | −0.604 | 0.907 | −0.604 |
| 270 | 3.977 | 4.479 | 3.425 | 0.467 | −0.604 | 0.403 | −0.604 |
| 272 | 3.977 | 4.479 | 3.425 | 0.467 | −0.604 | 0.403 | −0.604 |
| 274 | 3.977 | 4.479 | 3.425 | 0.467 | −0.604 | 0.403 | −0.604 |
| 276 | 3.977 | 4.479 | 3.425 | 0.467 | −0.604 | 0.403 | −0.604 |
| 278 | 3.977 | 4.479 | 3.425 | 0.467 | −0.604 | 0.403 | −0.604 |
| 280 | 3.977 | 4.479 | 3.425 | 0.467 | −0.604 | 0.403 | −0.604 |
| 282 | 3.977 | 4.479 | 3.425 | 0.467 | −0.604 | 0.403 | −0.604 |
| 284 | 3.977 | 4.479 | 3.425 | 0.467 | −0.604 | 0.403 | −0.604 |
| 286 | 3.977 | 4.479 | 3.425 | 0.467 | −0.604 | 0.403 | −0.604 |
| 288 | 3.977 | 4.479 | 3.425 | 0.467 | −0.604 | 0.403 | −0.604 |
| 290 | 3.977 | 4.479 | 3.425 | 0.467 | −0.604 | 0.403 | −0.604 |
| 292 | 3.977 | 4.479 | 3.425 | 0.467 | −0.604 | 0.403 | −0.604 |
| 294 | 3.977 | 4.479 | 3.425 | 0.467 | −0.604 | 0.403 | −0.604 |
| 296 | 3.977 | 4.479 | 3.425 | 0.467 | −0.604 | 0.907 | −0.604 |
| 298 | 3.977 | 4.479 | 3.425 | 0.467 | −0.604 | 1.41 | −0.604 |
| 300 | 3.977 | 4.479 | 3.425 | 0.467 | −0.604 | 2.418 | −0.604 |
| 302 | | | | | −0.604 | 2.921 | −0.604 |
| 304 | | | | | −0.604 | 3.928 | −0.604 |
| 306 | | | | | −0.604 | 4.432 | −0.604 |
| 308 | | | | | −0.604 | 5.439 | −0.604 |
| 310 | | | | | −0.604 | 5.942 | −0.604 |
| 312 | | | | | −0.604 | 6.445 | −0.604 |
| 314 | | | | | −0.604 | 7.452 | −0.604 |
| 316 | | | | | −0.604 | 7.955 | −0.604 |
| 318 | | | | | −0.604 | 8.458 | −0.604 |
| 320 | | | | | −0.604 | 8.961 | −0.604 |
| 322 | | | | | −0.604 | 9.968 | −0.604 |
| 324 | | | | | −0.604 | 10.471 | −0.604 |
| 326 | | | | | −0.604 | 10.974 | −0.604 |
| 328 | | | | | −0.604 | 11.477 | −0.604 |
| 330 | | | | | −0.604 | 11.98 | −0.604 |
| 332 | | | | | −0.604 | 12.483 | −0.604 |
| 334 | | | | | −0.604 | 12.986 | −0.604 |
| 336 | | | | | −0.604 | 13.488 | −0.604 |
| 338 | | | | | −0.604 | 13.991 | −0.604 |
| 340 | | | | | −0.604 | 14.494 | −0.604 |
| 342 | | | | | −0.604 | 14.997 | −0.604 |
| 344 | | | | | −0.604 | 15.5 | −0.604 |
| 346 | | | | | −0.604 | 16.002 | −0.604 |
| 348 | | | | | −0.604 | 16.505 | −0.604 |
| 350 | | | | | −0.604 | 17.008 | −0.604 |
| 352 | | | | | −0.604 | 17.008 | −0.604 |
| 354 | | | | | −0.604 | 17.51 | −0.604 |
| 356 | | | | | −0.101 | 18.013 | −0.604 |
| 358 | | | | | 0.907 | 18.013 | −0.604 |
| 360 | | | | | 1.41 | 18.515 | −0.604 |
| 362 | | | | | 1.914 | 19.018 | −0.604 |
| 364 | | | | | 2.921 | 19.52 | −0.604 |
| 366 | | | | | 3.928 | 19.52 | −0.604 |
| 368 | | | | | 4.432 | 20.023 | −0.604 |
| 370 | | | | | 4.935 | 20.525 | −0.604 |
| 372 | | | | | 5.439 | 20.525 | −0.604 |
| 374 | | | | | 6.445 | 21.028 | −0.604 |
| 376 | | | | | 6.948 | 21.028 | −0.604 |
| 378 | | | | | 7.452 | 21.53 | −0.604 |
| 380 | | | | | 7.955 | 21.53 | −0.604 |
| 382 | | | | | 8.458 | | −0.604 |
| 384 | | | | | 8.961 | | −0.604 |
| 386 | | | | | 8.961 | | −0.604 |
| 388 | | | | | 9.464 | | −0.604 |
| 390 | | | | | 9.968 | | −0.604 |
| 392 | | | | | 9.968 | | −0.604 |
| 394 | | | | | 10.471 | | −0.604 |
| 396 | | | | | 10.974 | | −0.604 |
| 398 | | | | | 11.477 | | −0.604 |
| 400 | | | | | 11.98 | | −0.604 |

Convective heat transfer is largely governed by the fluid flow regime within the boundary layer. Increasing the velocity gradient within the boundary layer will increase convective heat transfer. Whilst the Reynolds number is a key parameter governing whether the boundary layer is laminar or turbulent, it may transition due to surface texture or roughness and the local pressure gradient. The more complex motion of the container and coolant provided by this arrangement gives more degrees of freedom to control the thickness and velocity gradient within the boundary layer. This enables the apparatus to maximise convective heat transfer whilst eliminating slushing or ice formation that has hampered past attempts to achieve rapid cooling.

The present invention also seeks to provide a vending machine incorporating the apparatus described above. In a conventional vending machine, the entire storage cavity must be insulated, but insulation for a cavity storing perhaps 400 cans can typically only be achieved using insulating foam or mats or other materials which trap air in order to prevent heat transmission. These materials are relatively inefficient thermal insulators.

In addition to providing a vending machine which chills beverages exclusively on demand, the present invention provides a vending machine in which most cans or other beverage containers are storable at ambient temperature and only a small number, perhaps 16 or so, are storable at a reduced or drinking temperature.

As a result, the cavity in which the reduced temperature containers are stored can be insulated by more effective means, such as vacuum insulation panels. The cooling apparatus is provided between the ambient storage cavity and the chilled storage cavity.

The use of two storage zones significantly reduces the overall energy consumption and will also reduce the power rating required for the rapid cooling apparatus.

Additional low level chilling to the chilled storage cavity can be provided to maintain the correct temperature, but the energy consumption to maintain the temperature in a small vacuum-insulated capacity cavity is substantially lower than in conventional machines. Table 4 compares the energy consumption of such a vending machine compared with a conventional machine in which all the cans are maintained at a chilled temperature.

TABLE 4

| | Conventional | Inventive |
|---|---|---|
| | vending machine | vending machine |
| Power rating | 0.4 kW | 0.4 kW |
| Storage Capacity | 400 cans | 400 cans |
| Insulation | PU foam | Vacuum insulation |
| | | panel* |
| | | (for 16 - can chilled |
| | | storage) |
| Cooling rate | NA | 60 seconds |
| Energy consumption per can | 1080 kJ | 25-50 kJ |
| Energy consumption per day for | 4.8-5.5 kWh | 1 kWh |
| cooling (assuming 16 cans sold) | | |
| Operating costs per annum | [symbol] 340 | [symbol] 62 |

As can be seen the machine of the present invention will require 50 kJ to cool a can from ambient to drinking temperature (4-6° C.). In a typical scenario approximately 30 cans are sold each day. Assuming that these are dispensed randomly over 24 hours additional cooling to compensate for thermal losses in the chilled storage cavity is estimated to be a maximum of 0.5 kWh per day. Hence, the total energy consumption (in this scenario is will be 1 kWh for cooling 30 cans which remains an 80% saving compared with conventional machines.

1. A cooling apparatus comprising a cavity for receipt of a product to be cooled; rotation means to rotate a product received in the cavity and cooling liquid supply means to provide a cooling liquid to the cavity wherein the rotation means is adapted to rotate the product at a rotational speed of 90 revolutions per minute or more and is adapted to rotate the product for at least one cycle of: rotation for a predetermined rotation period and non-rotation for a predetermined pause period;
followed by a further predetermined period of rotation.

2. A cooling apparatus as claimed in claim 1 wherein the rotation means performs at least two cycles.

3. A cooling apparatus as claimed in claim 1 wherein the predetermined rotation period is 5 to 60 seconds.

4. A cooling apparatus as claimed in claim 3 wherein the predetermined pause period is 10 to 30 seconds.

5. A cooling apparatus as claimed in claim 1 wherein the rotation means is adapted to rotate the product at a rotational speed of 180 revolutions per minute or more.

6. A cooling apparatus as claimed in claim 1 wherein the cooling liquid supply means is adapted to provide a flow of cooling liquid to the cavity.

7. A cooling apparatus as claimed in claim 1 wherein the cooling liquid is supplied to the cavity at a temperature of −10° C. or less.

8. A cooling apparatus as claimed in claim 1 wherein the rotation means is adapted to rotate the product about an axis of the product and further comprises retaining means to prevent or substantially avoid axial movement of the product during rotation.

9. A vending apparatus comprising a cooling apparatus as claimed in claim 1 and further comprising insertion and removal means for inserting the product to be cooled into the cavity and removing the cooled product therefrom.

10. A vending apparatus as claimed in claim 9 further comprising storage means for storing a product or range of products and selection means for selecting a product from the storage means for insertion into the cavity.

11. A cooling apparatus as claimed in claim 1 wherein the rotation means performs at least three to six cycles.

12. A cooling apparatus as claimed in claim 1 wherein the rotation means performs at least three or four cycles.

13. A cooling apparatus comprising:
a cavity for receipt of a product to be cooled;
a rotation member to rotate an associated product received in the cavity;
a cooling liquid supply system to provide a cooling liquid to the cavity;
wherein the rotation member is adapted to rotate the associated product at a rotational speed of about 90 revolutions per minute or more and is adapted to rotate the associated product for at least one cycle of: rotation for a predetermined rotation period and non-rotation for a predetermined pause period; followed by a further predetermined period of rotation.
